(19) United States
(12) Patent Application Publication
(10) Pub. No.: US 2008/0028453 A1
(43) Pub. Date: Jan. 31, 2008

(54) Identity and access management framework

(76) Inventors: Thinh Nguyen, Sugar Land, TX (US); Shaun Cuttill, Katy, TX (US); Timothy T. Nguyen, Houston, TX (US); Mehrzad Mahdavi, Houston, TX (US)

Correspondence Address: OSHA . LIANG L.L.P. / SLB, 1221 MCKINNEY STREET, SUITE 2800, HOUSTON, TX, 77010, US

(21) Appl. No.: 11/731,011

(22) Filed: Mar. 29, 2007

Related U.S. Application Data
(60) Provisional application No. 60/787,613, filed on Mar. 30, 2006.

(51) Int. Cl. H04L 9/32

(52) U.S. Cl. 726/9; 726/10; 726/5

(57) ABSTRACT

A method for authenticating a user involves receiving a request from the user to access a resource, where the resource is associated with at least one authentication requirement, determining a trust level associated with access to the resource, obtaining user credentials based on the trust level associated with the resource, selecting an authentication method for authenticating the user based on the trust level associated with the resource, generating user authentication information based on the trust level associated with the resource and the user credentials obtained, where user authentication information relates to the user's environment while accessing the resource, sending the user authentication information to the resource, and granting access to the resource, if the user authentication information meets the at least one authentication requirement of the resource.

### CROSS REFERENCE TO RELATED APPLICATIONS

This application claims benefit of U.S. Provisional Application Ser. No. 60/787,613 entitled “Identity and Access Management Framework,” filed on Mar. 30, 2006, in the names of Shaun Cuttill, Thinh Nguyen, Tim Nguyen, and Mehrzad Mahdavi.

### BACKGROUND

One of the major challenges in today's word of electronic information is security. As the sharing of electronic information has become crucial to businesses' success, so have the strategies and methods for controlling access to important electronic resources.

For example, to facilitate the authentication of users only once to obtain access to multiple resources, the concept of single sign-on (SSO) was introduced. With SSO, users need to sign-on only once per SSO session. Subsequently, the authenticated user is automatically permitted access to a variety of resources that are within the authorization level of the user. Another security solution many enterprises employ is known as a circle of trust. Specifically, a circle of trust is established among service providers and at least one identity provider. The circle of trust ensures that each service provider and the identity provider know each other's identity and are authenticated with each other (i.e., trust is established amongst the services providers and the identity provider). Once a user's credentials have been verified and the user has been authenticated by the identity provider, the user is automatically authenticated to and recognized by all service providers within the circle of trust.

Often times, enterprises employ different access management technologies and security solutions in response to specific tactical problems. Typically, each of the access management technologies and/or security solutions operate independently, causing an often inefficient mix of solutions and technologies to be used.

### SUMMARY

In general, in one aspect, the invention relates to a computer usable medium. The computer readable medium comprising computer readable program code embodied therein for causing a computer system to receive a request from the user to access a resource, wherein the resource is associated with at least one authentication requirement, determine a trust level associated with access to the resource, obtain user credentials based on the trust level associated with the resource, select an authentication method for authenticating the user based on the trust level associated with the resource, generate user authentication information based on the trust level associated with the resource and the user credentials obtained, wherein user authentication information relates to the user's environment while accessing the resource, send the user authentication information to the resource, and grant access to the resource, if the user authentication information meets the at least one authentication requirement of the resource.

In general, in one aspect, the invention relates to a system for identity and access control management. The system comprises a resource manager configured to determine at least one authentication requirement of a resource, a trust engine configured to determine a trust level associated with access to the resource based on a plurality of trust rules, an authentication server configured to obtain user credentials based on the trust level associated with the resource and generate user authentication information, wherein user authentication information comprises information related to a user's environment while accessing the resource, and an access policy engine operatively connected to the resource manager and to the trust engine, configured to determine whether the user authentication information meets the at least one authentication requirement of the resource, wherein access to the resource is granted if the user authentication information meets the at least one authentication requirement of the resource.

In general, in one aspect, the invention relates to a method for authenticating a user. The method comprises receiving a request from the user to access a resource, wherein the resource is associated with at least one authentication requirement, determining a trust level associated with access to the resource, obtaining user credentials based on the trust level associated with the resource, selecting an authentication method for authenticating the user based on the trust level associated with the resource, generating user authentication information based on the trust level associated with the resource and the user credentials obtained, wherein user authentication information relates to the user's environment while accessing the resource, sending the user authentication information to the resource, and granting access to the resource, if the user authentication information meets the at least one authentication requirement of the resource.

### BRIEF DESCRIPTION OF DRAWINGS

FIG. 1 shows a framework for identity and access management in accordance with one or more embodiments of the invention.

FIG. 2 shows a trust level configuration in accordance with one or more embodiments of the invention.

FIG. 3 shows a flow chart in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention provide a framework for identity and access management for enterprise systems. More specifically, embodiments of the invention provide a framework and method for authentication of users that simplifies access control management for enterprise systems. Further, embodiments of the invention relate to providing a method for authentication of a user requesting access to applications of an enterprise system.

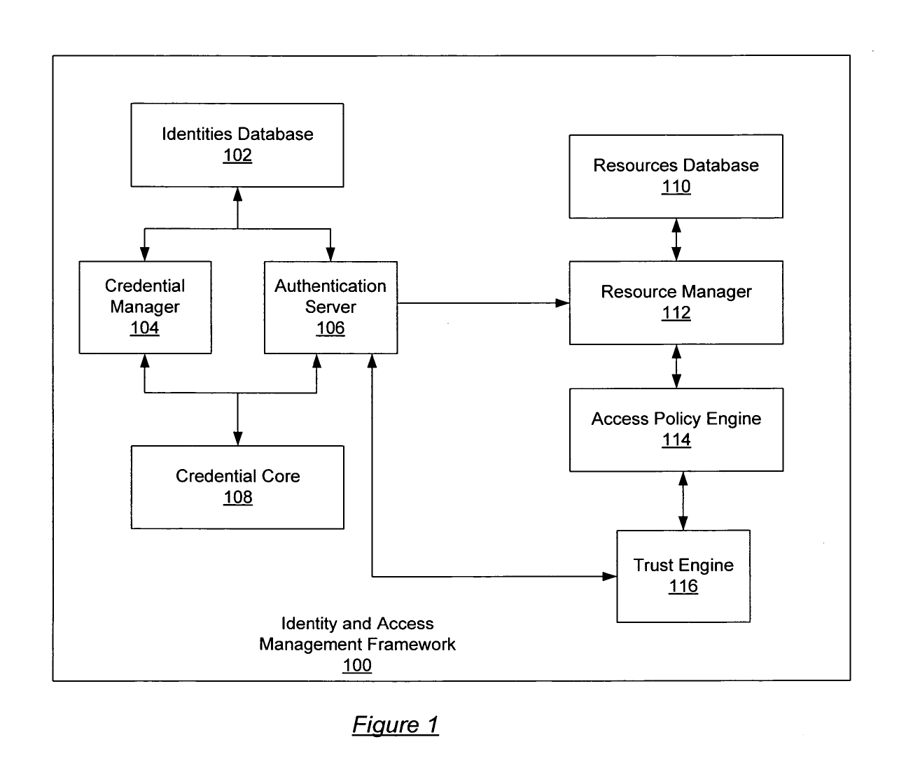

FIG. 1 shows an Identity and Access Management (IAM) framework (100) and the key components of the IAM framework (100). In one or more embodiments of the invention, the IAM framework (100) is a flexible, scalable framework that provides a security architecture that is used to provide information security. The IAM framework (100) connects multiple interdependent components, including an identities database (102), a credential manager (104), an authentication server (106), a credential core (108), a resources database (110), a resource manager (112), an access policy engine (114), and a trust engine (116). Each of the aforementioned components of the IAM framework (100) is described in detail below.

In one or more embodiments of the invention, the identities database (102) stores profiles associated with the identities of users that attempt to access resources. For example, the identities database (102) may store profiles associated with employees, contractors, visitors, managers, executives, and other enterprise roles. In one embodiment of the invention, the identities database (102) is connected to the credential manager (104) and the authentication server (106), although other arrangements may be possible.

The credential manager (104) stores and manages the various types of credentials that may be offered by a user identity. In one or more embodiments of the invention, credentials offered by a user identity may include user names and passwords, one-time passwords, smart card credentials, or any other type of authentication information capable of being provided by a user. In one or more embodiments, the credential manager (104) is operatively connected to the credential core (108).

In one embodiment of the invention, the credential core (108) includes a set of web service components that manage the lifecycle of different types of credentials. For example, the credential core (108) may manage the lifecycle of credentials such as a directory password, smart card credentials, a one-time password (OTP), federated identification, a question and answer (Q&A), public key infrastructure (PKI), etc. In one embodiment of the invention, a lifecycle of a credential includes the time period of validity of the credentials. Thus, the credential core (108) manages the initialization and expiration of credentials. Further, the credential core (108) can be enhanced to support new credential types. Although not shown in FIG. 1, the credential core (108) may be connected to a credential database that stores modules associated with each credential type. Those skilled in the art will appreciate that each credential module may be used as a standalone component or integrated with components from various vendors, such as the smart card management offerings of various vendors, including Microsoft Corporation, Sun Microsystems, Inc., etc. Those skilled in the art will appreciate that the credential core (108) may be used to construct a full credential lifecycle management solution or to augment the smart card management offerings of the various vendors.

The authentication server (106) is configured to authenticate credentials provided by a user to access resources in the IAM framework (100). In one embodiment of the invention, the authentication server (106) uses the trust model provided by the trust engine (116) (discussed below) to authenticate user(s) access to resources. More specifically, the authentication server (106) is configured to prompt users for appropriate user credentials, based on the credential types stored in the credential manager (104) and a minimum trust level required by the resource(s) being accessed.

In one or more embodiments of the invention, the authentication server (106) is configured to generate user authentication information (UAI) using the user credentials provided by the user and the user's environment variables. UAI may include parameters associated with the environment of the user attempting to access a resource via the IAM framework (100). In one or more embodiments of the invention, UAI may include an identity of the user, a terminal type or configuration of the user's system (e.g., the user may be using a kiosk at an airport terminal, a personal computer system, a networked computer, etc.), the location of the user's system (e.g., physical location, network location, etc.), the authentication method (e.g., username/password, OPT, smart card, etc.), and the age of the authentication (e.g., a time period associated with the user session). In one or more embodiments of the invention, the authentication server (106) provides the generated UAI to the resource manager (112). In one or more embodiments of the invention, the authentication server (106) also includes auditing capability. Auditing capabilities of the authentication server (106) may include determining how many times a particular type of credential is requested from a user, the number of times a user is prompted for credentials before the credentials are validating, and other performance-related information.

Those skilled in the art will appreciate that the IAM framework allows for the integration of any authentication server that meets an enterprise's security requirements. Further, those skilled in the art will appreciate that the chosen authentication server may need to be enhanced to take advantage of the IAM framework's trust model for preliminary resource access control.

Continuing with FIG. 1, the resources database (110) includes resources that a user attempts to access via the IAM framework (100). Resources in the resources database (110) may include web applications, legacy applications, operating system applications (such as Windows® applications (Windows is a registered trademark of Microsoft Corporation, located in Redmond, Wash.)), system applications, financial data applications, Linux applications, or any other type of application an enterprise may employ. The resource manager (112) manages the resources in the resources database (110) and allows a user to view resources that the user is permitted to access via the resource manager (112). Specifically, in one embodiment of the invention, the resource manager (112) may include a portal through which a user may view resources that the user is entitled to access.

In one embodiment of the invention, communication with a particular resource is facilitated using an assertion protocol that is required by that particular resource. Each resource in the resource data base (110) may require a different assertion protocol for communication. Assertion protocols supported by resources may include Kerberos, Security Assertion Markup Language (SAML), SiteMinder® (SiteMinder is a registered trademark of Computer Associates International, Inc., located in Islandia, N.Y.), Windows® Integrated Authentication (Windows is a registered trademark of Microsoft Corporation, located in Redmond, Wash.), Secure Entitlement and Authentication (SEA), etc. In one or more embodiments of the invention, the resource manager (112) includes functionality to translate UAI provided by the authentication server (106) to the appropriate assertion protocol required by the resource that a user is attempting to access. More specifically, in one embodiment of the invention, the resource manager (112) dynamically builds the correct assertion format from the UAI in order to automatically authenticate the user with the resource. To facilitate this translation, the resource manager (112) stores a mapping of the appropriate assertion protocol for each resource in the resource database (110).

Those skilled in the art will appreciate that the assertion protocol translation feature provided by the resource manager also enables single sign-on (SSO) capability for existing and new resources that support common assertion protocols.

As shown in FIG. 1, the resource manager (112) is connected to the access policy engine (114), and the access policy engine is connected to the trust engine (116) in accordance with one or more embodiments of the invention. In one or more embodiments of the invention, the access policy engine (114) is configured to deter mine whether a particular user has access to a requested resource. In one or more embodiments of the invention, the access policy engine (114) is configured to receive a trust level from the trust engine (116) and UAI from the resource manager (112). Further, the access policy engine (114) is also configured to provide trust level information to the resource manager (112). The information received from the trust engine (116) and the resource manager (112) is used by the access policy engine (114) to determine whether a user is permitted access to a requested resource.

Finally, in one or more embodiments of the invention, the trust engine (116) is configured to determine a requisite trust level for a user or a user session (i.e., the authenticated session opened by the IAM framework (100) when a user requests access to a resource). In one embodiment of the invention, the trust engine (116) is integrated with the authentication server (106) for more effective authenticating service. More specifically, based on UAI generated by the authentication server (106), the trust engine (116) assigns users' sessions an appropriate trust level. In one embodiment of the invention, the trust levels are defined by a set of business rules defined by an enterprise that employs the IAM framework. Those skilled in the art will appreciate that not all resources may be associated with a trust level.

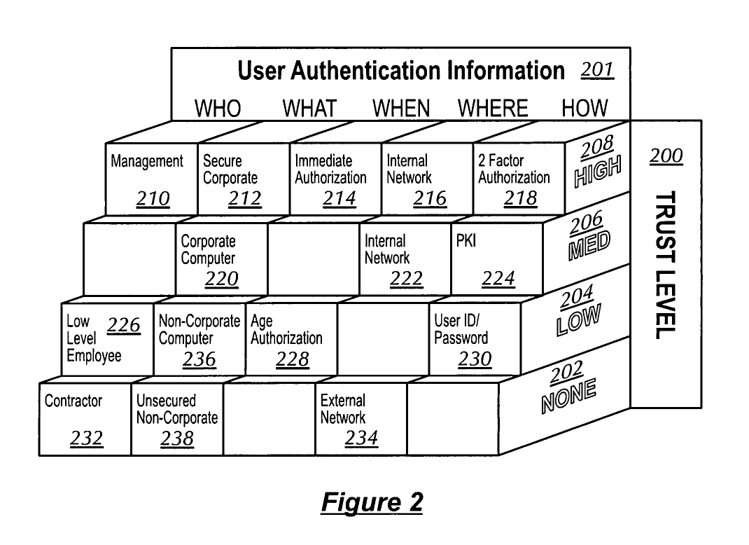

FIG. 2 shows the trust levels (200) that may be assigned to a user session in accordance with one or more embodiments of the invention. Further, FIG. 2 shows examples of UAI (201) that may be generated using user credentials and the particular trust level (200) required for access to a resource. In one or more embodiments of the invention, the IAM framework supports four trust levels: no trust level (202), a low (204) trust level, a medium (206) trust level, or a high (208) trust level. Because resources are associated with a trust level, an assigned trust level determines to which resource(s) a user is permitted to access.

For example, as shown in FIG. 2, UAI (201) is represented by the five columns labeled “Who,” “What,” “When,” “Where,” and “How.” “Who” represents an identity of a user, “What” represents the type of computing platforms the user is accessing the resource from, and “When” represents the age of the authentication/authorization session. “Where” represents a location of the user. In some instances, “Where” may indicate the type of network the user is using to access a resource. “How” identifies the mechanism or method by which authentication is accomplished.

Specifically, an identity associated with a high (208) trust level may be people in management (210) (e.g., managers, supervisors, executives, etc.). Resources that require a high (208) trust level may require that the computing platform the user is using is a trusted one, such as a secure corporate (212) computer/platform. The management identity may be associated with immediate authorization (214), and may be using an internal network (216) to access the resource. The authentication method used for a high (208) trust level may be a two-factor authorization (218) authentication method. Although not shown in FIG. 2, an identity associated with a medium (206) trust level may be a medium-level employee, such as an engineer or accountant, and platforms associated with a medium (206) trust level may include corporate computers (220). Further, a medium (206) trust level may be associated with a user using an internal network (222), where the user is authenticated using PKI credentials (224) or other public key cryptography authentication methods.

Continuing with FIG. 2, an identity associated with a low (204) trust level may be a low-level employee (226). For a low (204) trust level, the platform used by the user to access a resource may be non-corporate computer (236), and the low-level employee (226) may be authorized for a longer period of time, indicated by the “aged authorization” (228) under the “When” column. The authentication method may be a simple user identification and password authentication (230). For a contractor (232) identity, which may be associated with no trust level (202), the only UAI (201) obtained from the contractor (232) may be the location of the contractor (i.e., an external network (234)). Furthermore, the contractor may use an unsecured non-corporate computer (238) to access the resource.

Thus, based on the trust level associated with access to a resource, a user may be prompted for different user credentials and the authentication method chosen to authentication the user may depend on the trust level required. Those skilled in the art will appreciate that the examples provided for each trust level in FIG. 2 are used to illustrate possible scenarios under different trust levels and are not meant to limit the invention in any way.

In one embodiment of the invention, the IAM framework of FIG. 1 may be used by enterprises to build a roadmap for a security vision or direction that an enterprise has decided to follow. The various components of the IAM framework may then be used to implement and support the security vision that the enterprise has chosen. One feature of the IAM framework (100) shown in FIG. 1 is the separation of managing identities (users, system devices, etc.) from the management of resources (data, applications, etc.), with access control layers (e.g., the authentication server, resource manager, access policy engine, and trust engine) in between to facilitate access to resources. The separation in the design of the IAM framework allows more freedom in technology and vendor selection. Further, the IAM framework separates authentication from assertion. The components that handle authentication are not responsible for translating UAI into appropriate assertion protocols recognized by resources. Thus, new types of identity and authentication methods (OTP, Federated ID, etc.), may be introduced into the IAM framework without having to modify other related components.

Those skilled in the art will appreciate that the various components shown in the framework of FIG. 1 are not meant to limit the invention in any way. The IAM framework may include additional components not shown or may integrate components together and still offer at least the same functionality described above.

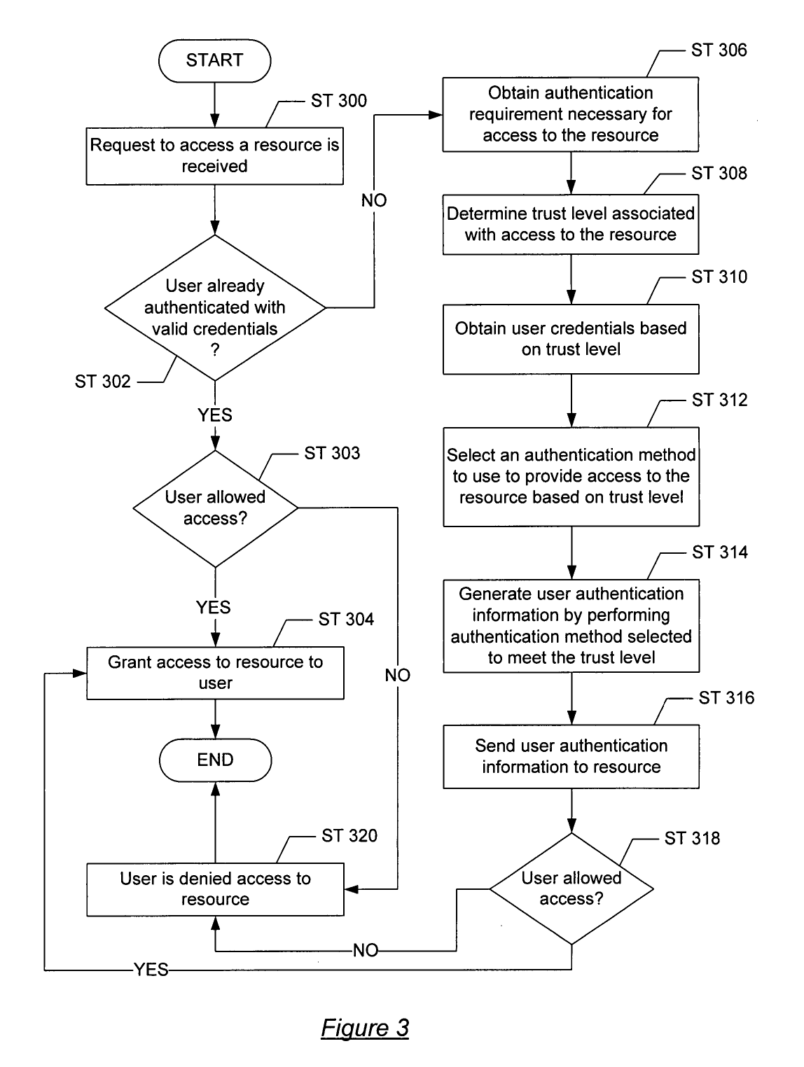

FIG. 3 shows a flow chart for using the IAM framework in accordance with one or more embodiments of the invention. Initially, a request to access a resource is received from a user (Step 300). Subsequently, a determination is made as to whether the user is already authenticated with valid credentials that meet the resource authentication requirements (Step 302). For example, the user may already be authenticated if the user is associated with an on-going user session. If the user is already authenticated, then a second determination is made as to whether the user is allowed access to the resource (Step 303). This determination is based on whether the trust level associated with the user session permits access to the resource requested. For example if the user is authenticated with a trust level associated with an employee, but attempts to access a resource that requires a higher trust level (e.g., that of a manger or executive) then the user may be denied access to the requested resource. If the user is allowed access to the resource, then the user is granted access to the resource (Step 304).

Alternatively, if the user has not been authenticated for access to the resource, then an authentication requirement necessary for access to the resource is requested from the resource (Step 306). For example, the resource may provide information such as the required identity of a user requesting access to the resource, the required authentication method that is used to authenticate any user attempting to access the resource, or any other authentication requirement that may be associated with the resource.

At this stage, a trust level associated with access to the resource is determined (Step 308). In one embodiment of the invention, the trust level associated with a particular resource is based on a set of trust rules defined by the enterprise implementing the identity and access control framework. In one embodiment of the invention, a resource may be associated with a default or a pre-defined trust level. Subsequently, based on the trust level associated with access to the resource, user credentials are obtained from the user (Step 310). As described above, user credentials may include PKI credentials, smart card credentials, etc.

Those skilled in the art will appreciate that although FIG. 3 illustrates that a trust level for a requested resource is obtained after user authentication information is obtained from a user, the order of steps 306 and 308 maybe interchanged. Said another way, a trust level associated with a resource may be used to obtain user credentials from a user. For example, if a determination is made that access to Resource A requires a trust level of “3” based on the trust rules, then the user credentials requested from a user attempting to access a resource from an unsecure platform (e.g., a mobile phone) may be adjusted to meet the required trust level. In this case, the user may be requested to provide biometric information during the authentication method (i.e., a stricter authentication method may be applied to authenticate the user because the user is accessing the resource from an unsecure platform). Said another way, the framework may request that the user provide a more secure or additional credentials to supplement other weak credentials to meet a particular trust level.

Continuing with FIG. 3, an authentication method for authenticating the user is selected based on the trust level associated with the resource (Step 312). In one embodiment of the invention, the authentication method used to authenticate the user is selected to meet the requirements of the trust level and may determine the type of user credentials requested from the user. For example, if the authentication method selected based on the trust level is a biometric authentication method, then the user's thumb print, retina scan, etc. may be obtained to perform the authentication method. As described above, an authentication method corresponding to a particular trust level may include a PKI authentication method, a two-factor authorization authentication method, a user identification and password authentication method, an authentication method involving biometric information of a user, etc. Upon selecting the authentication method for authenticating the user based on the trust level, the authentication method is performed with the user credentials provided by the user, and user authentication information is generated (Step 314).

In one embodiment of the invention, user authentication information is information associated with the user's environment at the time the user is attempting to access the resource. For example, identity information may include one or more of the following pieces of information: the status of the user (e.g., manager, contractor, employee, visitor, etc.), the type of terminal the user is using to access the resource, the configuration of the terminal type, where the user is accessing the resource from (e.g., internal/external network, physical location, etc.), the age of authentication (e.g., the last time the user authenticated for access to one or more resources/applications), the type of device that the user is using to access the resource (e.g., a PC, mobile device, etc.) and the authentication method used the last time the user authenticated.

Subsequently, the user authentication information is sent to the resource (Step 316). In one or more embodiments of the invention, the user authentication information is translated into an assertion protocol that is supported by the resource to which access is requested. That is, each resource supports an assertion protocol that is used to communicate with the resource. Thus, the appropriate assertion protocol is looked up in a mapping table that stores the resource name and the corresponding assertion protocol, and the user authentication information is subsequently translated into the assertion protocol that can be understood by the resource. At this stage, the user authentication information is compared with the authentication requirements of the resource, and if the user authentication information meets the authentication requirements of the resource (Step 318), then access to the resource is granted (Step 304). Alternatively, if the authentication information does not meet the requirements of the authentication requirements associated with the resource, then access to the resource is denied (Step 320). Those skilled in the art will appreciate that the resource itself may determine whether the user authentication information meets its own authentication requirements. Alternatively, a separate component that knows the authentication requirements of each resource may make this determination.

Embodiments of the invention provide a unique, scalable IAM framework which can help enterprises to effectively progress through the proven IAM roadmap. This framework allows enterprises to unify their interdependent IAM components, where each IAM component may be from a different vendor, and introduce new IAM technologies without having to rework existing, related components. Further, the access policy is simplified by applying common access policies across many applications that do not require granular access control, but only a few levels. Yet, complex application-level policies can still be left to the applications. Scalability is achieved by the additional information collected from the user (i.e., the location, age of the authentication session, the type of terminal, etc.). This additional information facilitates the use of emerging security applications that require more and different user information before granting access to resources.

Further, embodiments of the invention provides for establishing trust levels based on fewer rules than centralized access control policies. Enterprises are permitted to pre-screen resource access based on trust rules and automatically provide single sign-on (SSO) functionality to resources that implement standard assertion protocol(s). Such preliminary resource access control results in less unnecessary network traffic and better user experience. Further, the design of the IAM framework allows for minimal re-architecture or integration when needed.

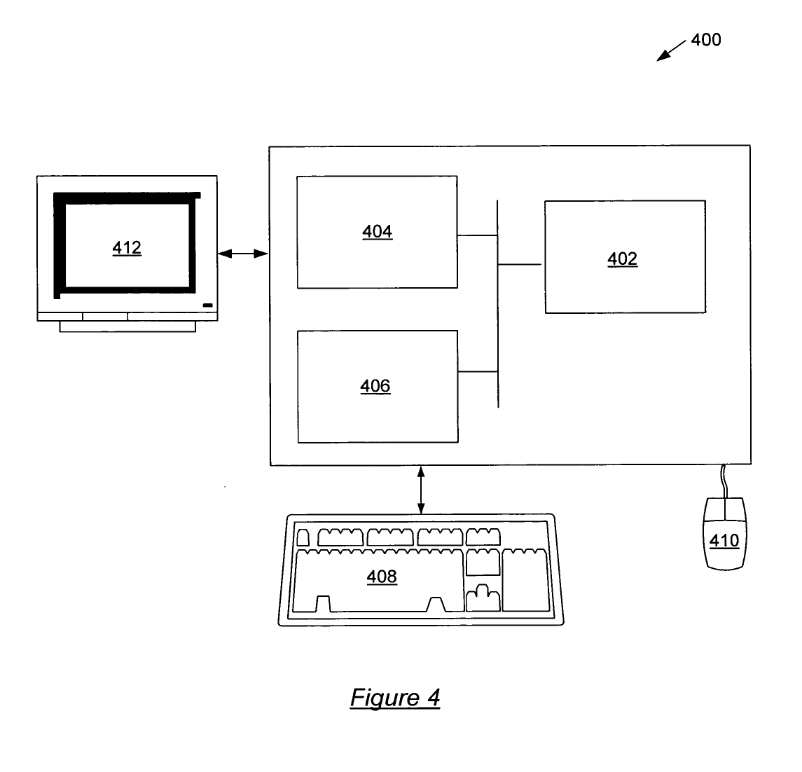

The invention may be implemented on virtually any type of computer regardless of the platform being used. For example, as shown in FIG. 4, a networked computer system (400) includes a processor (402), associated memory (404), a storage device (406), and numerous other elements and functionalities typical of today's computers (not shown). The networked computer system (400) may also include input means, such as a keyboard (408) and a mouse (410), and output means, such as a monitor (412). The networked computer system (400) is connected to a local area network (LAN) or a wide area network (e.g., the Internet) (not shown) via a network interface connection (not shown). Those skilled in the art will appreciate that these input and output means may take other forms. Further, those skilled in the art will appreciate that one or more elements of the aforementioned computer (400) may be located at a remote location and connected to the other elements over a network. Further, the invention may be implemented on a distributed system having a plurality of nodes, where each portion of the invention (e.g., resource manager, authentication server, access policy engine, etc.) may be located on a different node within the distributed system. In one embodiment of the invention, the node corresponds to a computer system. Alternatively, the node may correspond to a processor with associated physical memory.

Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for authenticating a user, comprising:
receiving a request from the user to access a resource, wherein the resource is associated with at least one authentication requirement;
determining a trust level associated with access to the resource;
obtaining user credentials based on the trust level associated with the resource;
selecting an authentication method for authenticating the user based on the trust level associated with the resource;
generating user authentication information based on the trust level associated with the resource and the user credentials obtained, wherein user authentication information relates to the user's environment while accessing the resource;
sending the user authentication information to the resource; and
granting access to the resource, if the user authentication information meets the at least one authentication requirement of the resource.

2. The method of claim 1, wherein generating user authentication information comprises authenticating the user using the selected authentication method.

3. The method of claim 1, wherein the trust level is determined using a plurality of trust rules.

4. The method of claim 1, further comprising:
modifying the resource to support the authentication method selected to meet the requirements of the trust level associated with the resource.

5. The method of claim 1, wherein the trust level associated with the resource is one selected from a group consisting of no trust level, a low trust level, a medium trust level, and a high trust level.

6. The method of claim 1, wherein user authentication information comprises at least one selected from a group consisting of an identity of the user, a user credential type, a location of the user, and a type of the requested resource.

7. The method of claim 6, wherein the user credential type comprises one selected from a group consisting of smart card credentials, a user identification and password, a one-time password, and PKI credentials.

8. The method of claim 1, wherein the resource comprises one selected from a group consisting of a web application, a legacy application, a system application, a financial data application, and an operating system application.

9. The method of claim 1, wherein the authentication method comprises one selected from a group consisting of a PKI authentication, a two-factor authorization authentication, a user identification and password authentication, and a one-time password authentication.

10. The method of claim 1, wherein sending the user authentication information to the resource comprises translating the user authentication information to an assertion protocol supported by the requested resource.

11. The method of claim 10, wherein the assertion protocol is one selected from a group consisting of Kerberos, Security Assertion Markup Language (SAML), SiteMinder, Windows Integrated Authentication, and Security Extension Architecture (SEA).

12. The method of claim 10, wherein a mapping of the resource and the supported assertion protocol is stored in a resource manager.

13. A system for identity and access control management, comprising:
a resource manager configured to determine at least one authentication requirement of a resource;
a trust engine configured to determine a trust level associated with access to the resource based on a plurality of trust rules;
an authentication server configured to obtain user credentials based on the trust level associated with the resource and generate user authentication information, wherein user authentication information comprises information related to a user's environment while accessing the resource; and
an access policy engine operatively connected to the resource manager and to the trust engine, configured to determine whether the user authentication information meets the at least one authentication requirement of the resource,
wherein access to the resource is granted if the user authentication information meets the at least one authentication requirement of the resource.

14. The system of claim 13, wherein the authentication server is further configured to apply an authentication method selected based on the trust level associated with the resource to authenticate a user and to generate user authentication information.

15. The system of claim 14, wherein the resource is modified to support the authentication method selected to meet the requirements of the trust level associated with the resource.

16. The system of claim 13, wherein the trust level associated with the resource is one selected from a group consisting of no trust level, a low trust level, a medium trust level, and a high trust level.

17. The system of claim 13, wherein user authentication information comprises at least one selected from a group consisting of an identity of the user, a credential type, a location of the user, and a type of the requested resource.

18. The system of claim 13, wherein user authentication information comprises at least one selected from a group consisting of an identity of the user, a user credential type, a location of the user, and a type of the requested resource.

19. The system of claim 18, wherein the user credential type comprises one selected from a group consisting of smart card credentials, a user identification and password, a one-time password, and PKI credentials.

20. The system of claim 13, wherein the resource comprises one selected from a group consisting of a web application, a legacy application, a system application, a financial data application, and an operating system application.

21. The system of claim 13, wherein the resource manager is further configured to send the user authentication information to the resource, wherein sending the user authentication information to the resource comprises translating the user authentication information to an assertion protocol supported by the requested resource.

22. The system of claim 21, wherein the assertion protocol is one selected from a group consisting of Kerberos, Security Assertion Markup Language (SAML), SiteMinder, Windows Integrated Authentication, and Security Extension Architecture (SEA).

23. The system of claim 21, wherein a mapping of the resource and the supported assertion protocol is stored in the resource manager.

24. A computer usable medium comprising computer readable program code embodied therein for causing a computer system to:
receive a request from the user to access a resource, wherein the resource is associated with at least one authentication requirement;
determine a trust level associated with access to the resource;
obtain user credentials based on the trust level associated with the resource;
select an authentication method for authenticating the user based on the trust level associated with the resource;
generate user authentication information based on the trust level associated with the resource and the user credentials obtained, wherein user authentication information relates to the user's environment while accessing the resource;
send the user authentication information to the resource; and
grant access to the resource, if the user authentication information meets the at least one authentication requirement of the resource.
